(19) United States
(12) Patent Application Publication
(10) Pub. No.: US 2013/0024606 A1
(43) Pub. Date: Jan. 24, 2013

(54) NONVOLATILE SEMICONDUCTOR MEMORY DEVICE

(71) Applicants: Takahiro SUZUKI, Chigasaki-shi (JP); Mami Kakoi, Yokohama-shi (JP)

(72) Inventors: Takahiro SUZUKI, Chigasaki-shi (JP); Mami Kakoi, Yokohama-shi (JP)

(21) Appl. No.: 13/428,507

(22) Filed: Mar. 23, 2012

(30) Foreign Application Priority Data
Jul. 21, 2011 (JP) 2011-160143

(51) Int. Cl. G06F 12/00

(52) U.S. Cl. 711/103; 711/E12.008

(57) ABSTRACT

According to one embodiment, a nonvolatile semiconductor memory device comprises a first memory block and a second memory block, and a control circuit. In read operation, when a read target block is the first memory block, the control circuit determines whether the first memory block is single-level or multi-level according to a first flag, and stores a first determination result thereof. While the read target block is the first memory block, the control circuit reads the first memory block as single-level or multi-level according to the first determination result. When the read target block is changed from the first memory block to the second memory block, the control circuit erases the first determination result.

### CROSS-REFERENCE TO RELATED APPLICATIONS

This application is based upon and claims the benefit of priority from prior Japanese Patent Application No. 2011-160143, filed Jul. 21, 2011, the entire contents of which are incorporated herein by reference.

### FIELD

Embodiments described herein relate generally to a nonvolatile semiconductor memory device.

### BACKGROUND

In recent years, as the performances of computers improve, the size of processed data increases, and data are diversified. Under such circumstances, it is required to write data at high speed.

Nowadays, in a flash memory, an ordinary memory cell for storing one bit of information per cell (single-level memory) and a memory cell for storing two bits of information (or more than two bits of information) per cell (multi-level memory) are known. In general, the single-level memory has a higher performance than the multi-level memory. For example, the single-level memory is more advantageous than the multi-level memory in reliability and high writing speed.

### BRIEF DESCRIPTION OF THE DRAWINGS

FIG. 1 is a block diagram illustrating an example of entire configuration of a nonvolatile semiconductor memory device according to the present embodiment;

FIG. 2 is a circuit diagram illustrating an example of configuration of a memory cell array 1 and a column control circuit 2 as shown in FIG. 1;

FIG. 3 is a block diagram illustrating a configuration of each block BLK as shown in FIG. 1;

FIG. 4 is a flowchart illustrating write operation of the nonvolatile semiconductor memory device according to the present embodiment;

FIG. 5A is a graph illustrating a threshold distribution of a cell during writing to an LP address in multi-level write process;

FIG. 5B is a graph illustrating a threshold distribution of a cell during writing to an UP address in multi-level write process;

FIG. 5C is a graph illustrating a threshold distribution of a cell during single-level write process;

FIGS. 6A and 6B are circuit diagrams illustrating a read circuit in the nonvolatile semiconductor memory device according to the present embodiment;

FIG. 7 is a timing chart illustrating various signals during operation of a read circuit as shown in FIGS. 6A and 6B;

FIG. 8 is a flowchart illustrating read operation of the nonvolatile semiconductor memory device according to the present embodiment;

FIG. 9 is a flowchart illustrating read operation of the nonvolatile semiconductor memory device according to the present embodiment; and

FIG. 10 is a flowchart illustrating a modification of read operation of the nonvolatile semiconductor memory device according to the present embodiment.

### DETAILED DESCRIPTION

In general, according to one embodiment, a nonvolatile semiconductor memory device comprises: a first memory block and second memory block; and a control circuit. The first memory block and the second memory block has a memory cell capable of writing as single-level or multi-level. The control circuit writes data to the first memory block and the second memory block and reads data from the first memory block and the second memory block, according to a command given from outside. In write operation, when a write target block is the first memory block, the control circuit writes a first flag indicating whether the first memory block is single-level or multi-level to a memory cell in the first memory block. When the write target block is the second memory block, the control circuit writes a second flag indicating whether the second memory block is single-level or multi-level to a memory cell in the second memory block. In read operation, when a read target block is the first memory block, the control circuit determines whether the first memory block is single-level or multi-level according to the first flag, and stores a first determination result thereof. While the read target block is the first memory block, the control circuit reads the first memory block as single-level or multi-level according to the first determination result. When the read target block is changed from the first memory block to the second block, the control circuit erases the first determination result, determines whether the second memory block is single-level or multi-level according to the second flag, and stores a second determination result thereof. While the read target block is the second memory block, the control circuit reads the second memory block as single-level or multi-level according to the second determination result.

In recent years, as the size of data increases, multi-level memories may be used. For example, there is a product using both of a single-level memory and a multi-level memory within a memory in a mixed manner. This product uses the single-level memory and the multi-level memory according to designation (command input) given from the outside (host). At this occasion, in accordance with the designation given from the outside, each memory cell functions as the single-level memory or the multi-level memory.

The mixed-type nonvolatile memory including the multi-level memory and the single-level memory needs to maintain synchronization between writing and reading processes. More specifically, when a memory cell having multi-level data does not read the data as multi-level, false data are obtained, which causes false reading process. Likewise, when a memory cell having single-level data does not read the data as single-level, false data are obtained, which causes false reading process. This is because, in the nonvolatile memory storing data using difference of threshold distributions in the memory cells, threshold determination potentials during reading process are different between the multi-level and the single-level.

In the present embodiment, using the UP flag and the LP flag, a determination is made as to whether data stored in the memory cell are single-level data or multi-level data, and an appropriate reading mode is set. A nonvolatile semiconductor memory device is provided that reduces false reading of data and improves the speed as a result. Hereinafter, the nonvolatile semiconductor memory device will be explained more specifically.

The present embodiment will be hereinafter explained with reference to drawings. In the drawings, the same portions are denoted with the same reference numerals.

### Example of Entire Configuration

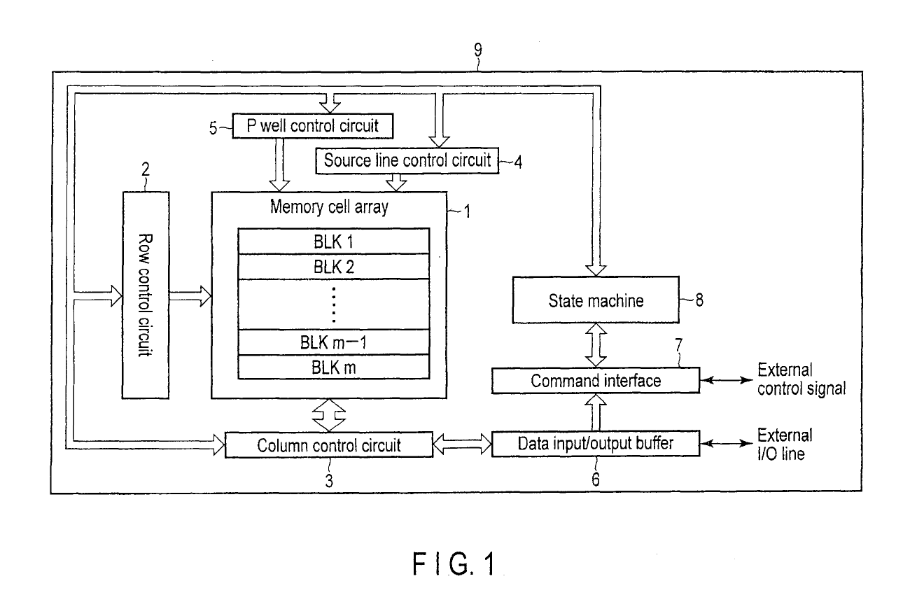

An example of configuration of a nonvolatile semiconductor memory device according to the present embodiment will be hereinafter explained with reference to FIGS. 1, 2 and 3. In this case, a NAND flash memory is explained as an example of nonvolatile semiconductor memory device. However, the present embodiment is not limited thereto. The present embodiment can be generally applied to memories capable of writing data as single Level Cell (SLC) and multi Level Cell (MLC).

FIG. 1 is a block diagram illustrating an example of entire configuration of a nonvolatile semiconductor memory device according to the present embodiment.

As shown in FIG. 1, a nonvolatile semiconductor memory device 9 includes a memory cell array 1, a row control circuit 2, a column control circuit 3, a source line control circuit 4, a P well control circuit 5, a data input/output buffer 6, a command interface 7, and a state machine 8.

The memory cell array 1 includes a plurality of blocks BLK1 to BLKm (when the blocks are not distinguished from each other, the blocks will be hereinafter simply referred to as blocks BLK). Erase operation is performed for each of the blocks BLK, and in accordance with designation given from the outside (host) for each block BLK, they are used in single-level mode or multi-level mode. In other words, each block BLK is the minimum unit selectively used in the single-level mode or the multi-level mode.

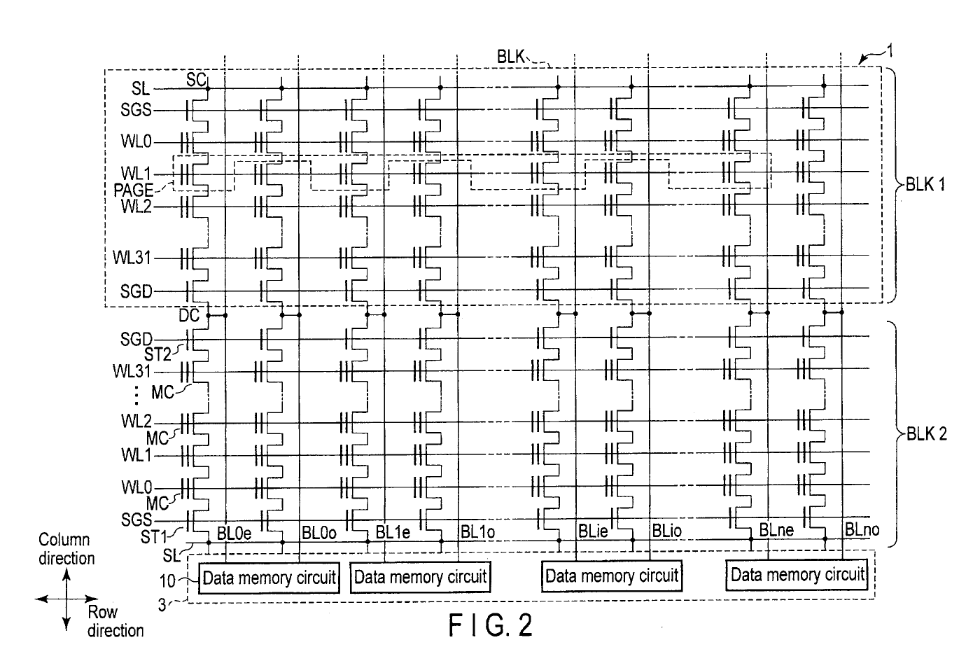

As shown in FIG. 2, the memory cell array 1 includes a plurality of word lines WL0 to WL31 (when the word lines are not distinguished from each other, the word lines will be hereinafter simply referred to as word lines WL), a plurality of bit lines BL0 to BLn (when the bit lines are not distinguished from each other, the bit lines will be hereinafter simply referred to as bit lines BL), and a plurality of select gates SGS, SGD. A memory cell MC is arranged at a portion corresponding to each of crossing positions between the plurality of word lines WL and the plurality of bit lines BL. In the memory cell array 1, the plurality of memory cells MC are arranged on a matrix. Selection transistor ST1, SGS are arranged at each of crossing positions between the plurality of select gates SGS, SGD and the plurality of bit lines BL.

In accordance with the control of the state machine 8, the row control circuit 2 selects a word line WL in the memory cell array 1, and applies a voltage required to read, write, or erase operation to the selected word line WL.

In accordance with the control of the state machine 8, the column control circuit 3 reads data of a memory cell MC in the memory cell array 1 via a bit line BL, and detects the state of the memory cell MC in the memory cell array 1 via the bit line BL. The column control circuit 3 also applies a write control voltage to a memory cell MC in the memory cell array 1 via a bit line BL to perform write operation on the memory cell MC.

In accordance with the control of the state machine 8, the source line control circuit 4 applies a necessary voltage to the source line SL in the memory cell array 1.

In accordance with the control of the state machine 8, the P well control circuit 5 applies a necessary voltage to a well formed in a semiconductor substrate in the memory cell array 1 (for example, p-well).

The data input/output buffer 6 is connected to an external host (not shown) via an I/O line, and inputs/outputs data to/from the host. In other words, the data input/output buffer 6 receives write data, address data, and command data from the host, and transmits read data to the host. More specifically, the data input/output buffer 6 transmits the write data from the host to the column control circuit 2, and transmits the read data from the column control circuit 2 to the host. In order to select a memory cell MC, address data from the host are transmitted to the column control circuit 2 and the row control circuit 3 via the state machine 8. Further, command data from the host are transmitted to the command interface 7.

The command interface 7 receives a control signal from the host, and determines whether the data given to the data input/output buffer 6 are write data, command data, or address data. When the data are determined to be command data, the command interface 7 transmits the data to the state machine 8 as a command signal.

The state machine 8 receives a command given from the host via the command interface 7, and controls the overall operation of the nonvolatile semiconductor memory device 9, e.g., write/read/erase processes.

FIG. 2 is a circuit diagram illustrating an example of configuration of a memory cell array 1 and a column control circuit 2 as shown in FIG. 1.

As shown in FIG. 2, the memory cell array 1 is constituted by a plurality of blocks BLK, and each block BLK includes a plurality of NAND strings arranged in a row direction. Each NAND string is constituted by, for example, 32 memory cells MC made by connecting current paths in series and selection gate transistors ST1, ST2.

The memory cell MC has an FG structure including a floating gate formed on a p-type semiconductor substrate with a gate insulating film interposed therebetween (conductive layer) and a control gate formed on the floating gate with a gate insulating film interposed therebetween. Alternatively, the memory cell MC may have a MONOS structure which is constituted by a tunnel insulating film, a charge storage layer, a block insulating film, and a gate electrode functioning as a word line WL which are formed in order on a semiconductor substrate, not shown. The drain of the memory cell MC is electrically connected to the bit line BL, and the source thereof is electrically connected to the source line SL.

The source region of the selection transistor ST1 is connected to a drain region of one end of the plurality of memory cells MC connected in series, and the drain region is connected to the bit line BL via a drain contact DC. On the other hand, the drain region of the selection transistor ST2 is connected to a source region of the other end of the plurality of memory cells MC connected in series, and the source region thereof is connected to the source line SL via a source contact SC. Both of the selection transistors ST1, ST2 may not be necessary. As long as a NAND string 61 can be selected, only any one of them may be provided.

The control gates of the plurality of memory cells MC arranged in the row direction are commonly connected to the word line WL. The plurality of selection gate transistors ST2 arranged in the row direction are commonly connected to the select gate SGD, and the plurality of selection gates ST1 arranged in the row direction are commonly connected to the select gate SGS.

The column control circuit 3 includes a plurality of data memory circuits 10. In each data memory circuit 10, pairs of even-numbered and odd-numbered bit lines (BL0e, BL0o), (BL1e, BL1o) . . . (BLie, BLio) . . . (BLne, BLno) are connected, for example.

The data memory circuit 10 controls transfer of read/write data during read/write operation. In this example, each data memory circuit 10 is provided for a pair of bit lines (for example, BL1e, BL1o). More specifically, the read/write operation is simultaneously executed on the memory cells connected to one of each pair of bit lines (even-numbered bit lines BLe1 to BLen or odd-numbered bit lines BLo1 to BLon). In this manner, one page is constituted by the plurality of memory cells MC connected to the common word lines WL, wherein one of each pair of bit lines BL is connected. In other words, one page is constituted by half of the memory cells MC connected to the common word line WL. The read/write operation is performed in units of pages.

In another example, there is an example where a data memory circuit 10 is connected to each bit line. In this example, the read/write operation is simultaneously executed on the memory cells MC connected to all the bit lines. One page is constituted by the plurality of memory cells MC connected to the common word lines WL and connected to each bit line. In other words, one page is constituted by all of the memory cells MC connected to the common word line WL. The read/write operation is performed in units of pages.

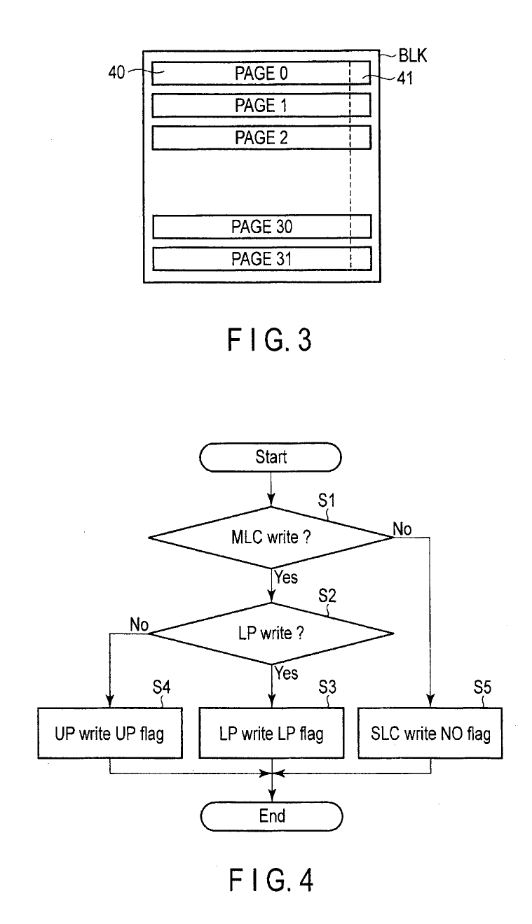

FIG. 3 is a block diagram illustrating a configuration of each block BLK as shown in FIG. 1.

As shown in FIG. 3, each block BLK has a plurality of pages PAGE0 to PAGE31 (when the pages are not distinguished from each other, the pages will be hereinafter simply referred to as pages PAGE). Each page PAGE includes a memory region 40 and a flag region 41.

The memory region 40 is a region to which a user writes data. Single-level data or multi-level data can be written to this memory region 40. In this case, in this example, multi-level data can be written by compressing the data. An LP (Lower Page) address is assigned to a lower bit of the multi-level data (for example, two-bit data), and an UP (Upper Page) address is assigned to an upper bit thereof.

The flag region 41 is a region to which data of the UP flag and LP flag are written. For example, this flag region 41 has one bit in each page PAGE. In each block BLK, for example, there exists one column, i.e., 32 bits. For example, the UP flag is a one-bit flag written to the flag region 41 when data are written to the UP address of the memory region 40. For example, the LP flag is a one-bit flag written to the flag region 41 when data are written to the LP address of the memory region 40. In other words, by checking the UP flag or the LP flag, it is possible to identify whether multi-level data or single-level data are written to the memory region 40.

### <Write Operation>

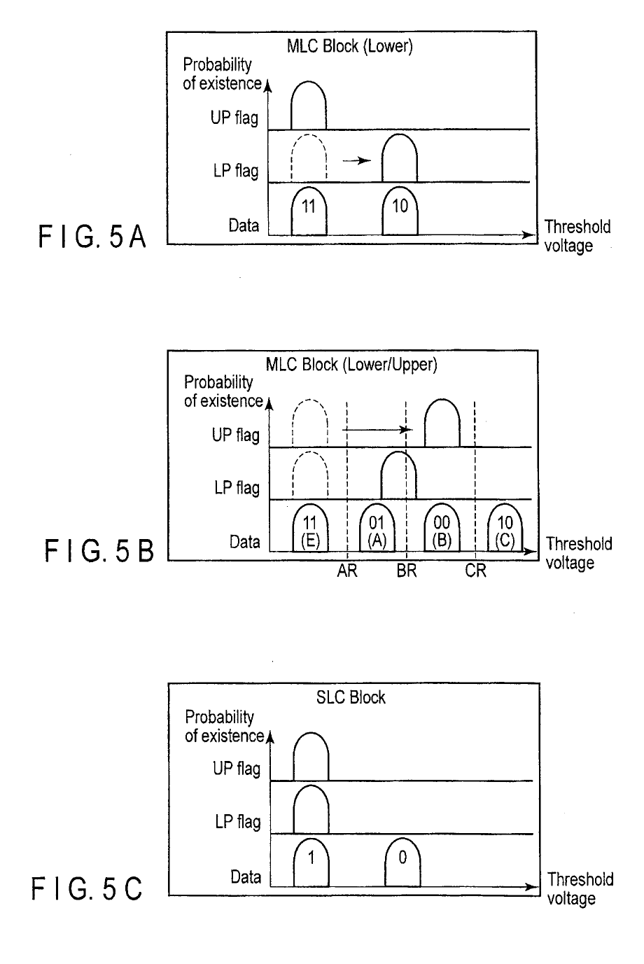

Write operation of the nonvolatile semiconductor memory device according to the present embodiment will be hereinafter explained with reference to FIGS. 4, 5A, 5B and 5C.

FIG. 4 is a flowchart illustrating write operation of the nonvolatile semiconductor memory device according to the present embodiment. FIG. 5A is a graph illustrating a threshold distribution of a cell during write process to the LP address in the multi-level write process. FIG. 5B is a graph illustrating a threshold distribution of a cell during write process to the UP address in the multi-level write process. FIG. 5C is a graph illustrating a threshold distribution of a cell in the single-level write process.

As shown in FIG. 4, first, in step S1, a determination is made as to whether write data given from the host are written as multi-level or not. More specifically, according to a command signal (dedicated command) given to the state machine 8 from the host via the command interface 7 simultaneously with the write data, the state machine 8 determines whether to write data to a write target block BLK as multi-level.

When the process is determined to be the multi-level write process in step S1, a determination is made as to whether data are written to the LP address in step S2 subsequent to step S1.

When the process is determined to be write process to the LP address in step S2, data are written to the LP address in the memory region 40 in step S3 subsequent to step S2. At this occasion, as shown in FIG. 5A, the memory cell MC stores two data “11”, “10” in the ascending order of the threshold voltage. In this case, the threshold voltage “11” is less than the threshold voltage of AR (A Level Read), and the threshold voltage “10” is more than the threshold voltage of AR. In other words, in the read operation, a determination is made as to whether it is data “11” or data “10” based on AR.

At the same time as the data write process to the LP address, the LP flag is written to the flag region 41. This LP flag is written at the same level as the threshold voltage of data “10”. In other words, the LP flag is written at a level higher than the threshold voltage of AR. For this reason, whether the LP flag is written or not can be determined based on AR. At this occasion, the UP flag is not written.

On the other hand, when the process is determined not to be write process to the LP address (i.e., the process is determined to be write process to the UP address) in step S2, data are written to the UP address in the memory region 40 in step S4 subsequent to step S3. At this occasion, as shown in FIG. 5B, the memory cell MC stores four “11 (E level)”, “01 (A level)”, “00 (B level)”, “10 (C level)” in the ascending order of the threshold voltage. In this case, the threshold voltage “11” is less than the threshold voltage of AR. The threshold voltage “01” is more than the threshold voltage of AR but is less than the threshold voltage of BR (B Level Read). The threshold voltage “00” is more than the threshold voltage of BR but is less than the threshold voltage of CR (C Level Read). Further, the threshold voltage “10” is higher than the threshold voltage of CR. In other words, in the read operation, a determination is made as to whether it is data “11”, data “01”, data “00”, or data “10” based on AR, BR, or CR.

At the same time as the data write process to the UP address, the UP flag is written to the flag region 41. This UP flag is written at the same level as the threshold voltage of data “00”. In other words, the UP flag is written at a level higher than the threshold voltage of BR but is written at a threshold voltage different from the LP flag. For this reason, whether the UP flag is written or not can be determined based on BR.

On the other hand, when the process is determined not to be multi-level write process (i.e., the process is determined to be single-level write process) in step S1, single-level data are written to the memory region 40 in step S5 subsequent to step S4. At this occasion, as shown in FIG. 5C, the memory cell MC stores two data “1”, “0” in the ascending order of the threshold voltage. In this case, the threshold voltage “1” is equivalent to the threshold voltage “11” of the LP write process, and the threshold voltage “0” is equivalent to the threshold voltage “10” of the LP write process. That is, in the read operation, a determination is made as to whether it is data “1” or data “0” based on AR.

When single-level write process is performed according to external designation as described above, the flags (LP flag and UP flag) written in the multi-level write process (LP write and UP write processes) are not written.

### <Read Circuit>

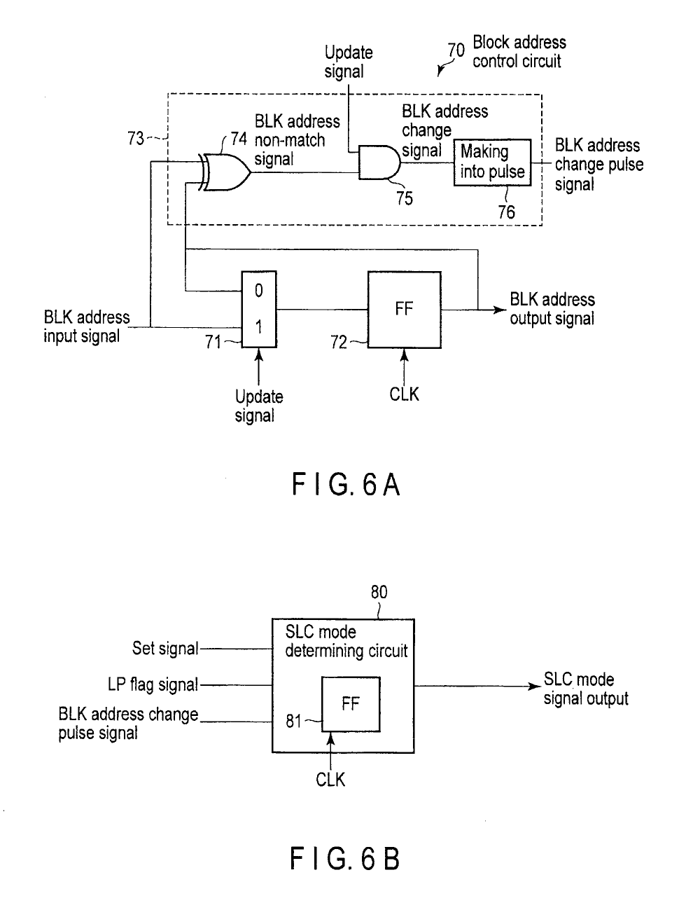

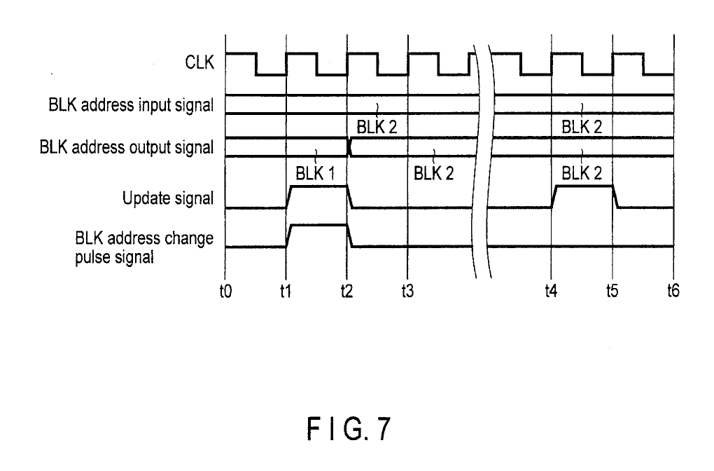

The read circuit of the nonvolatile semiconductor memory device according to the present embodiment will be hereinafter explained with reference to FIGS. 6A, 6B and 7.

FIGS. 6A and 6B are circuit diagrams illustrating a portion of the read circuit in the nonvolatile semiconductor memory device according to the present embodiment. More specifically, FIG. 6A is a circuit diagram illustrating a block address control circuit in the read circuit. FIG. 6B is a circuit diagram illustrating an SLC mode determining circuit in the read circuit. This read circuit is included in the state machine (control circuit) 8 as shown in FIG. 1.

As shown in FIGS. 6A and 6B, the read circuit according to the present embodiment includes a block address control circuit 70 and an SLC mode determining circuit 80.

In the read operation, the block address control circuit 70 stores a block address according to a block address input signal received from the host, and transmits a block address output signal to each control unit, not shown, so as to perform read operation at the block address. In the present embodiment, the block address control circuit 70 determines whether the block address where the read operation is performed is changed or not, and when it is changed, a block address change pulse signal is transmitted to the SLC mode determining circuit.

More specifically, as shown in FIG. 6A, the block address control circuit 70 includes a selection circuit 71, a flip-flop circuit 72, and a block address change determining circuit 73.

The selection circuit 71 receives a new block address signal according to a block address input signal from the host and the block address signal stored in the flip-flop circuit 72. Then, the selection circuit 71 selects, according to an update signal, one of the received two block address signals and transmits the selected block address signal to the flip-flop circuit 72.

The flip-flop circuit 72 receives the block address signal from the selection circuit 71, and stores (latches) the block address. Then, the flip-flop circuit 72 transmits the block address signal received according to a clock CLK to the selection circuit 71 and the block address change determining circuit 73. Further, the flip-flop circuit 72 transmits the block address signal (block address output signal) to each control unit. Each control unit performs read operation at the block address according to the block address output signal.

The block address change determining circuit 73 includes an EX-OR circuit 74, an AND circuit 75, and a pulsing circuit 76.

The EX-OR circuit 74 receives a new block address signal according to a block address input signal from the host and the block address signal stored in the flip-flop circuit 72, and performs EX-OR (Exclusive OR) operation thereof. More specifically, when these block address signals do not match each other, the EX-OR circuit 74 transmits a block address non-match signal to the AND circuit 75.

The AND circuit 75 receives the update signal and the block address non-match signal from the EX-OR circuit 74, and performs AND operation thereof. More specifically, when the block address non-match signal and the update signal are received, a block address change signal is transmitted to the pulsing circuit 76.

The pulsing circuit 76 receives the block address change signal from the AND circuit 75, and transmits a block address change pulse signal obtained by making this into a pulse.

In the read operation, the SLC mode determining circuit 80 determines whether the block BLK subjected to the read operation is in the SLC mode or not, and when the block BLK is in the SLC mode, the SLC mode determining circuit 80 stores the information thereof (determination result). Then, the SLC mode determining circuit 80 transmits the SLC mode signal to each control unit and the host.

More specifically, as shown in FIG. 6B, during read operation, the SLC mode determining circuit 80 receives a set signal and an LP flag signal to determine whether the block BLK subjected to the read operation is in the SLC mode or not. When the LP flag is “L” level at this occasion, the SLC mode determining circuit 80 determines that the read block BLK is in the SLC mode, and a set circuit, not shown, causes the internal flip-flop circuit 81 to store (latch) the SLC mode information as a determination result thereof.

Then, the flip-flop circuit 81 transmits an SLC mode signal according to the clock CLK to each control unit. As soon as it is recognized that the block BLK subjected to the read operation is in the SLC mode (single-level write process is performed), an internal signal established with a dedicated command for reading data as single-level is established as OR relationship. Accordingly, in the inside of the memory, single-level write state can be represented without providing any dedicated command.

The SLC mode determining circuit 80 outputs an SLC mode information signal (state signal representing single-level write process) to the host as a status. Accordingly, a determination can be made by the host as to whether the read target block has multi-level or single-level. The method for outputting to the outside can be performed with a dedicated or existing status command.

On the other hand, when the SLC mode determining circuit 80 receives the block address change pulse signal from the block address control circuit 70 during read operation, the SLC mode determining circuit 80 determines that the read target block BLK is changed, and using a reset circuit, not shown, to reset the SLC mode information stored in the flip-flop circuit 81. Thereafter, by receiving the set signal and the LP flag signal again, a determination is made as to whether a changed, new read target block BLK is in the SLC mode or not.

FIG. 7 is an example of timing chart illustrating various signals during operation of a read circuit as shown in FIGS. 6A and 6B. FIG. 7 shows a case where the read target block BLK changes from a block BLK1 to a block BLK2.

As shown in FIG. 7, first, as times t0 to t1, an address signal of the block BLK2 is input as a block address input signal, and an address signal of the block BLK1 is output as a block address output signal. More specifically, the flip-flop circuit 72 stores the address of the block BLK1, and the selection circuit 71 receives the address signal of the block BLK1 from the flip-flop circuit 72 and the address signal of the block BLK2 from the host. At this occasion, the update signal is at “L” level, and therefore, the selection circuit 71 outputs the address signal of the block BLK1. The EX-OR circuit 74 receives the address signal of the block BLK1 from the flip-flop circuit 72 and the address signal of the block BLK2 from the host. Since the received address signals do not match each other, the EX-OR circuit 74 outputs a block address non-match signal. The AND circuit 75 receives this block address non-match signal, but since the update signal is not received (“L” level), none of the block address change signal and the block address change pulse signal are output (“L” level).

Subsequently, at times t1 to t2, the update signal is at “H” level. At this occasion, the address signals given to the EX-OR circuit 74 do not match each other, and accordingly, a block address non-match signal is output. The AND circuit 75 receives the block address non-match signal and the update signal. Therefore, the AND circuit 75 outputs the block address change signal, and as a result, the block address change pulse signal is output via the pulsing circuit 76 (“H” level). At this occasion, the selection circuit 71 outputs the address signal of the block BLK2, so that the flip-flop circuit 72 operates to store the address of the block BLK2.

Thereafter, at the times t2 to t3, as soon as the update signal attains “L” level, the block address change pulse signal attains “L” level. Further, the flip-flop circuit 72 outputs the address signal of the block BLK2 as the block address output signal.

On the other hand, as shown by times t4 to t5, the address signal of the same block BLK2 is input/output as the block address input signal and the block address output signal, the address signals received by the EX-OR circuit 74 match each other. Accordingly, the block address non-match signal is not output. As a result, the AND circuit 75 receives the update signal, but does not receive the block address non-match signal, and therefore, the block address change signal and the block address change pulse signal are not output (“L” level).

### <Read Operation>

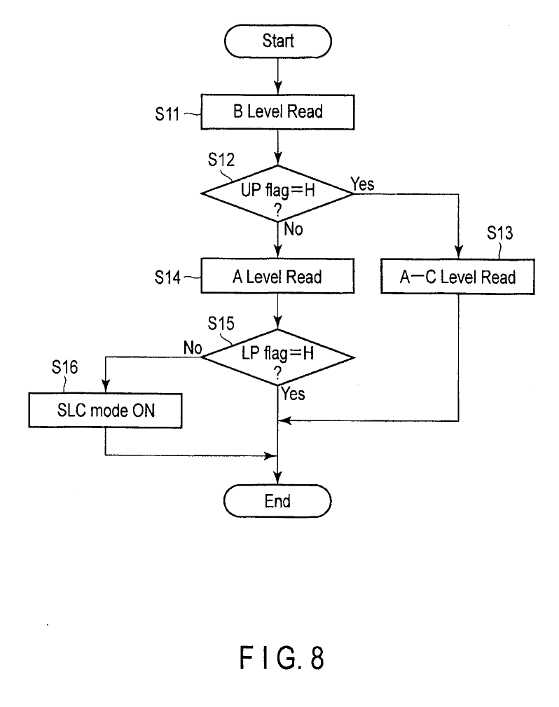

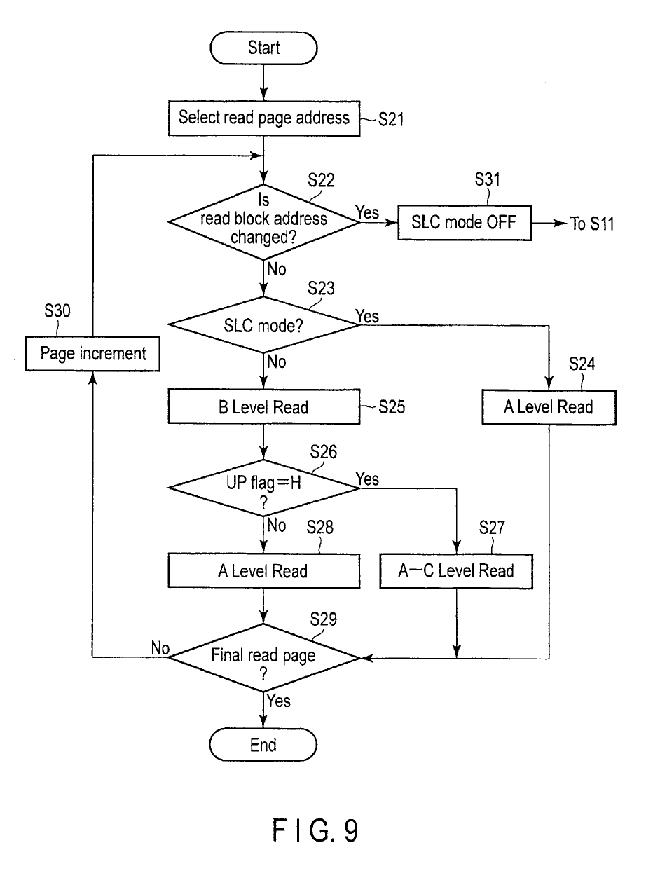

The read operation of the nonvolatile semiconductor memory device according to the present embodiment will be hereinafter explained with reference to FIGS. 8 and 9.

FIG. 8 is a flowchart illustrating read operation of the nonvolatile semiconductor memory device according to the present embodiment. It should be noted that FIG. 8 shows a case where the first page PAGE is accessed in the read operation. More specifically, this shows a case where the first page PAGE in the block BLK selected as the read target is accessed. In this case, first, in the inside, the read operation is performed at the LP address as the read operation for the multi-level memory. This will be hereinafter explained in detail.

As shown in FIG. 8, first, BR operation is performed in step S11. More specifically, the state machine 8 performs the BR operation on the read target block BLK according to a command signal (dedicated command) given to the state machine 8 via the command interface 7 from the host. More specifically, data written to the memory region 40 are read based on the threshold voltage of BR. At this occasion, at this same time, the UP flag written to the flag region 41 is also read.

Subsequently, in step S12, a determination is made as to whether the UP flag is at “H” level or not (whether the UP flag is written or not). In other words, a determination is made as to whether data are written to an address up to the UP address in the memory region 40.

When the UP flag is determined to be at “H” level in step S12, the AR operation and the CR operation are performed in step S13. In other words, data written to the memory region 40 are read based on the threshold voltage of AR and the threshold voltage of CR, so that the read operation at the UP address is performed. As described above, when the UP flag is determined to be at “H” level, it is found that the data are written to the address up to the UP address. As a result, data can be determined to be written as multi-level to the block BLK selected as the read target.

On the other hand, when the UP flag is determined not to be at “H” level (“L” level) in step S12, the AR operation is performed in step S14. More specifically, by reading the data written to the memory region 40 based on the threshold voltage of AR, the read operation at the LP address is performed. As described above, read operation is performed again upon changing the read voltage (from BR to AR), whereby correct data at the LP address are read.

At this occasion, a distribution of data written to an address only up to the LP address is not different from that of data written as single-level. For this reason, it is necessary to determine whether the block BLK selected as the read target is what is written as multi-level to an address up to the LP address or what is written as single-level.

Accordingly, subsequently, in step S15, a determination is made as to whether the LP flag is at “H” level or not (whether the LP flag is written or not). In other words, a determination is made as to whether data are written to the LP address in the memory region 40. In other words, a determination is made as to whether the data are written as multi-level or single-level to the block BLK selected as the read target.

When the LP flag is determined to be at “H” level in step S15, it can be determined that data are written to the LP address. As a result, data can be determined to be written as multi-level to the block BLK selected as the read target.

On the other hand, when the LP flag is determined not to be at “H” level (“L” level) in step S15, the SLC mode is turned ON in step S16 subsequent thereto. More specifically, it is determined that the data are written as single-level to the block BLK selected as the read target. Accordingly, the SLC determining circuit 80 causes the flip-flop circuit 81 to store the SLC mode information.

FIG. 9 is a flowchart illustrating read operation of the nonvolatile semiconductor memory device according to the present embodiment. It should be noted that FIG. 9 shows a case where a page PAGE subsequent to FIG. 8 is accessed in the read operation. In other words, this shows a case where pages PAGE subsequent to the first page PAGE in the block BLK selected as the read target are accessed.

As shown in FIG. 9, first, in step S21, a read page address is selected.

Subsequently, in step S22, the block address control circuit 70 determines whether the read block address is changed or not. In other words, a determination is made as to whether the block address to which the page address selected as the read target in step S21 has been changed from the block address selected as the read target in the past.

When the read target block address is determined not to have been changed in step S22 (when no block address change pulse signal is output), the SLC mode determining circuit 80 determines whether the block address of the read target is in the SLC mode or not in step S23.

When the block address is determined to be in the SLC mode (SLC mode is ON) in step S23, the read operation is performed for single-level memory. More specifically, in step S24, the AR operation is performed. More specifically, the single-level read operation is performed by reading data written to the memory region 40 based on the threshold voltage of AR.

On the other hand, in step S23, when the block address is determined not to be in the SLC mode (the SLC mode is turned OFF), multi-level read operation is performed. In other words, the read operation at the LP address is performed as the multi-level read operation. More specifically, in step S25, the BR operation is performed. More specifically, data written to the memory region 40 are read based on the threshold voltage of BR. At this occasion, at this same time, the UP flag written to the flag region 41 is also read.

Subsequently, in step S26, a determination is made as to whether the UP flag is at “H” level or not (whether the UP flag is written or not). In other words, a determination is made as to whether data are written to an address up to the UP address in the memory region 40.

When the UP flag is determined to be at “H” level in step S26, the AR operation and the CR operation are performed in step S27. In other words, data written to the memory region 40 are read based on the threshold voltage of AR and the threshold voltage of CR, so that the read operation at the UP address is performed.

On the other hand, when the UP flag is determined not to be at “H” level (“L” level) in step S26, the AR operation is performed in step S27. More specifically, by reading the data written to the memory region 40 based on the threshold voltage of AR, the read operation at the LP address is performed.

Thereafter, in step S29, a determination is made as to whether the read page PAGE is the final read page or not. When the page PAGE read in step S29 is not the final read page, a subsequent page address is read in step S30, and thereafter, in step S22, a determination is made as to whether the read target block address is changed or not. When the read page PAGE is the final read page in step S29, the read operation is terminated. The determination as to whether the page is the final read page or not in step S29 and the page increment in step S30 may be performed automatically by the internal state machine 8 or may be performed according to a command signal given from the outside.

On the other hand, when the read target block address is determined to have been changed in step S22 (when the block address change pulse signal is output), the SLC mode is turned OFF in step S31. In other words, the SLC determining circuit 80 resets (erases) the SLC mode information stored in the flip-flop circuit 81. Thereafter, in step Sil as shown in FIG. 8, a determination is made again as to whether the read target block address is multi-level or single-level. When the read target block address is determined to be multi-level in step S31, the SLC mode is already OFF, and therefore, step S31 is skipped and step S11 is performed.

### <Effects>

According to the above embodiment, in the nonvolatile semiconductor memory device capable of writing data as single-level and multi-level, during the multi-level write process, data of the UP flag and/or the LP flag are written to the flag region 41 at the same time as the write process of data to the memory region 40. As a result, during the read operation, by checking the UP flag and/or the LP flag inside of the memory, a determination can be made as to whether the data written to the memory cell are multi-level or single-level. By outputting the determination result to the outside of the memory as the status command, the read control corresponding to multi-level or single-level can be performed automatically, and false reading operation can be solved.

The signal representing the determination result is effective until the block address is subsequently switched. In other words, this determination result is maintained while the same block is read. Therefore, when a subsequent page address within the block address is read at the block address determined to be written as single-level, the single-level read is performed. The single-level read is advantageous in the speed and the reliability as compared with the multi-level read process. According to the above embodiment, when the read target block BLK is determined to be single-level read process, the process can be executed with the performance of the single-level read process until the read target block BLK is changed.

In the present embodiment, the multi-level includes four values, for example. However, the present embodiment is not limited thereto. The multi-level may include eight or sixteen values.

### <Modification>

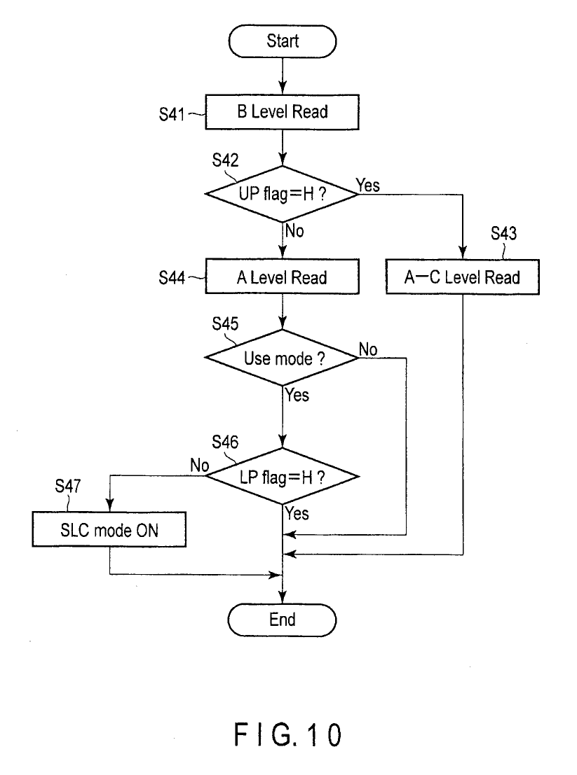

A modification of the nonvolatile semiconductor memory device according to the present embodiment will be hereinafter explained with reference to FIG. 10.

FIG. 10 is a flowchart illustrating a modification of read operation of the nonvolatile semiconductor memory device according to the present embodiment. It should be noted that FIG. 10 shows a case where the first page PAGE is accessed in the read operation. In other words, FIG. 10 shows a modification of the flowchart of the read operation as shown in FIG. 8.

As shown in FIG. 10, first, the BR operation is performed in step S41. More specifically, data written to the memory region 40 are read based on the threshold voltage of BR. At this occasion, at this same time, the UP flag written to the flag region 41 is also read.

Subsequently, in step S42, a determination is made as to whether the UP flag is at “H” level or not (whether the UP flag is written or not). In other words, a determination is made as to whether data are written to an address up to the UP address in the memory region 40.

When the UP flag is determined to be at “H” level in step S42, the AR operation and the CR operation are performed in step S43. In other words, data written to the memory region 40 are read based on the threshold voltage of AR and the threshold voltage of CR, so that the read operation at the UP address is performed. As described above, when the UP flag is determined to be at “H” level, it is found that the data are written to the address up to the UP address. As a result, data can be determined to be written as multi-level to the block BLK selected as the read target.

On the other hand, when the UP flag is determined not to be at “H” level (“L” level) in step S42, the AR operation is performed in step S44. More specifically, by reading the data written to the memory region 40 based on the threshold voltage of AR, the read operation at the LP address is performed. As described above, read operation is performed again upon changing the read voltage (from BR to AR), whereby correct data at the LP address are read.

Subsequently, in step S45, a determination is made as to whether the mode is a use mode. More specifically, a determination is made as to whether it is necessary to recognize whether data are written as single-level or multi-level to the block BLK selected as the read target. In other words, a determination is made as to whether the SLC mode determining circuit 80 is to be operated or not. This kind of determination as to whether the mode is the use mode or not can be achieved by making a one-bit use mode flag, for example.

For example, a controller, not shown, in the state machine 8 having received a dedicated command from the outside executes process for writing data as single-level or multi-level to the block BLK selected as the read target. More specifically, for example, when the controller recognizes that the data written to the block BLK are single-level or multi-level, it is not necessary to determine the data are single-level or multi-level again, and the use mode is turned OFF. On the other hand, for example, when the controller does not recognize that the data written to the block BLK are single-level or multi-level, it is necessary to determine the data are single-level or multi-level again, and the use mode is turned ON. In this manner, according to the command from the controller, ON/OFF of the use mode is controlled.

Alternatively, ON/OFF of the use mode may be stored to a special storage region (RAM and the like) in the nonvolatile semiconductor memory device 9 in advance, and during the read operation, it is set to a register, not shown in the state machine 8, whereby ON/OFF of the use mode may be controlled. Still alternatively, it may be stored in a portion of the memory cell array 1.

As described above, when the mode is determined not to be a use mode in step S45, the read operation is terminated. At this occasion, since the SLC mode determining circuit 80 does not receive the LP flag signal, no determination is made as to whether the read target block BLK is in the SLC mode or not (single-level or multi-level).

On the other hand, when the mode is the use mode in step S45, a determination is made as to whether the block BLK selected as the read target is multi-level or single-level like FIG. 8.

Accordingly, subsequently, in step S46, a determination is made as to whether the LP flag is at “H” level or not (whether the LP flag is written or not). In other words, a determination is made as to whether data are written to the LP address in the memory region 40. In other words, a determination is made as to whether the data are written as multi-level or single-level.

When the LP flag is determined to be at “H” level in step S46, it can be determined that data are written to the LP address. As a result, data can be determined to be written as multi-level to the block BLK selected as the read target.

On the other hand, when the LP flag is determined not to be at “H” level (“L” level) in step S46, the SLC mode is turned ON in step S47 subsequent thereto. More specifically, it is determined that the data are written as single-level to the block BLK selected as the read target. Accordingly, the SLC determining circuit 80 causes the flip-flop circuit 81 to store the SLC mode information.

### <Effects>

According to the above embodiment, the determination as to whether the data written to the block BLK selected as the read target are single-level or multi-level is not executed as necessary. Accordingly, the determination is made as to whether data are single-level or multi-level, so that this can reduce the degraded performance (e.g., the speed or the reliability) to the minimum.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonvolatile semiconductor memory device comprising:
a first memory block and a second memory block having a memory cell capable of writing as single-level or multi-level; and
a control circuit configured to write data to the first memory block and the second memory block or to read data from the first memory block and the second memory block, according to a command input from outside,
wherein in write operation, when a write target block is the first memory block, the control circuit writes a first flag indicating whether the first memory block is single-level or multi-level to a memory cell in the first memory block, and when the write target block is the second memory block, the control circuit writes a second flag indicating whether the second memory block is single-level or multi-level to a memory cell in the second memory block, and
in read operation, when a read target block is the first memory block, the control circuit determines whether the first memory block is single-level or multi-level according to the first flag, and stores a first determination result thereof, and while the read target block is the first memory block, the control circuit reads the first memory block as single-level or multi-level according to the first determination result, and when the read target block is changed from the first memory block to the second memory block, the control circuit erases the first determination result, determines whether the second memory block is single-level or multi-level according to the second flag, and stores a second determination result thereof, and while the read target block is the second memory block, the control circuit reads the second memory block as single-level or multi-level according to the second determination result.

2. The device of claim 1, wherein
each of the first memory block and the second memory block includes a page, and the control circuit writes and reads data for each page, and
the first determination result is a result determined according to the first flag included in a page read first in the first memory block, and the second determination result is a result determined according to the second flag included in a page read first in the second memory block.

3. The device of claim 1, wherein the control circuit outputs the first determination result and the second determination result to the outside.

4. The device of claim 1, wherein the first flag is a flag written when the first memory block is multi-level, and the second flag is a flag written when the second memory block is multi-level.

5. The device of claim 1, wherein the control circuit comprises
a block address control circuit configured to determine whether the read target block is changed or not from the first memory block to the second memory block, and
a SLC mode determining circuit configured to store the first determination result or the second determination result, and determine whether the first memory block or the second memory block is read as single-level or multi-level.

6. The device of claim 5, wherein
the block address control circuit transmits a block address change pulse signal to the SLC mode determining circuit, when the block address control circuit transmits a block address signal of the first memory block and receives a block address signal of the second memory block, and
the SLC mode determining circuit erases the first determination result, when the SLC mode determining circuit receives the block address change pulse signal transmitted from the block address control circuit.

7. A nonvolatile semiconductor memory device comprising:
a first memory block and a second memory block having a memory cell capable of writing as single-level or multi-level; and
a control circuit configured to write data to the first memory block and the second memory block or to read data from the first memory block and the second memory block, according to a command input from outside,
wherein in read operation, when a read target block is the first memory block, the control circuit determines whether the first memory block is single-level or multi-level according to a first flag written to the first memory block, and stores a first determination result thereof, and while the read target block is the first memory block, the control circuit reads the first memory block as single-level or multi-level according to the first determination result, and when the read target block is changed from the first memory block to the second memory block, the control circuit erases the first determination result, determines whether the second memory block is single-level or multi-level according to a second flag written to the second memory block, and stores a second determination result thereof, and while the read target block is the second memory block, the control circuit reads the second memory block as single-level or multi-level according to the second determination result.

8. The device of claim 7, wherein
each of the first memory block and the second memory block includes a page, and the control circuit writes and reads data for each page, and
the first determination result is a result determined according to the first flag included in a page read first in the first memory block, and the second determination result is a result determined according to the second flag included in a page read first in the second memory block.

9. The device of claim 7, wherein the control circuit outputs the first determination result and the second determination result to the outside.

10. The device of claim 7, wherein the first flag is a flag written when the first memory block is multi-level, and the second flag is a flag written when the second memory block is multi-level.

11. The device of claim 7, wherein the control circuit comprises
a block address control circuit configured to determine whether the read target block is changed or not from the first memory block to the second memory block, and
a SLC mode determining circuit configured to store the first determination result or the second determination result, and determine whether the first memory block or the second memory block is read as single-level or multi-level.

12. The device of claim 11, wherein
the block address control circuit transmits a block address change pulse signal to the SLC mode determining circuit, when the block address control circuit transmits a block address signal of the first memory block and receives a block address signal of the second memory block, and
the SLC mode determining circuit erases the first determination result, when the SLC mode determining circuit receives the block address change pulse signal transmitted from the block address control circuit.

13. A nonvolatile semiconductor memory device comprising:
a first memory block and a second memory block having a memory cell capable of writing as single-level or multi-level; and
a control circuit which writes data to the first memory block and the second memory block and reads data from the first memory block and the second memory block, according to a command given from outside,
wherein in write operation, when a write target block is the first memory block, the control circuit writes a first flag indicating whether the first memory block is single-level or multi-level to a memory cell in the first memory block, and when the write target block is the second memory block, the control circuit writes a second flag indicating whether the second memory block is single-level or multi-level to a memory cell in the second memory block.

14. The device of claim 13, wherein
in read operation, when a mode is a determination use mode, and a read target block is the first memory block, the control circuit determines whether the first memory block is single-level or multi-level according to the first flag, and stores a first determination result thereof, and while the read target block is the first memory block, the control circuit reads the first memory block as single-level or multi-level according to the first determination result, and when the read target block is changed from the first memory block to the second memory block, the control circuit erases the first determination result, determines whether the second memory block is single-level or multi-level according to the second flag, and stores a second determination result thereof, and while the read target block is the second memory block, the control circuit reads the second memory block as single-level or multi-level according to the second determination result, and
in read operation, when the mode is not the determination use mode, and the read target block is the first memory block or the second block, the control circuit does not make determination according to the first flag or the second flag, and reads the first memory block or the second memory block as single-level or multi-level.

15. The device of claim 14, wherein
each of the first memory block and the second memory block includes a page, and the control circuit writes and reads data for each page, and
the first determination result is a result determined according to the first flag included in a page read first in the first memory block, and the second determination result is a result determined according to the second flag included in a page read first in the second memory block.

16. The device of claim 14, wherein the control circuit outputs the first determination result and the second determination result to the outside.

17. The device of claim 13, wherein the first flag is a flag written when the first memory block is multi-level, and the second flag is a flag written when the second memory block is multi-level.
